(19) United States
(12) Patent Application Publication
(10) Pub. No.: US 2025/0278089 A1
(43) Pub. Date: Sep. 4, 2025

(54) WIRELESS COMMUNICATION SYSTEM, WIRELESS COMMUNICATION METHOD, AND STORAGE MEDIUM

(71) Applicant: NEC Corporation, Tokyo (JP)

(72) Inventor: Masayoshi OHUCHI, Tokyo (JP)

(73) Assignee: NEC Corporation, Tokyo (JP)

(21) Appl. No.: 19/062,147

(22) Filed: Feb. 25, 2025

(30) Foreign Application Priority Data
Mar. 1, 2024 (JP) 2024-030900

(51) Int. Cl. G05D 1/249; G01J 5/00; G05D 101/00; G05D 111/30; H04B 7/155; H04W 4/38

(52) U.S. Cl. CPC G05D 1/249; G01J 5/0025; H04B 7/15507; H04W 4/38; G05D 2101/22; G05D 2111/32

(57) ABSTRACT

A wireless communication system includes a receiver that is configured to be capable of self-propelled movement, performs movement control of the receiver based on a transmission timing of sensing information of a sensor, an installation position of the sensor, and a range in which reception is possible in a case where the sensing information is received from the sensor, and receives the sensing information of the sensor.

### CROSS-REFERENCE TO RELATED APPLICATIONS

This application is based upon and claims the benefit of priority from Japanese patent application No. 2024-030900, filed on Mar. 1, 2024, the disclosure of which is incorporated herein in its entirety by reference.

### TECHNICAL FIELD

The present disclosure relates to a wireless communication system, a wireless communication method, and a storage medium.

### BACKGROUND ART

In recent years, the use of Internet of Things (IoT) systems has been increasing. In an IoT system, sensors that perform sensing are generally installed on-site, and the data collected by the sensors is aggregated at an edge, and then transmitted to the cloud. Here, an “edge” refers to a device that serves as a point that delivers the data collected by the sensors, to a line for transmission to a device that processes the data. Sensors include wired-type and wireless-type sensors. Wired-type sensors require wiring and placement, which makes installation cumbersome. On the other hand, wireless-type sensors also have disadvantages, such as a limited transmission and reception range, and the possibility of interference with other radio waves, which prevents a correct reading from being obtained. Therefore, wired-type and wireless-type sensors each have advantages and disadvantages. In addition, although equipment exists that transmits directly to the cloud from a sensor, the cost and functionality are generally high, which makes management complicated in cases where a large number of sensors are used.

Furthermore, in order to receive data from a sensor that is further away than a wireless communication range, a repeater that relays data from the sensor is arranged between the edge and the sensor. In cases where coverage cannot be achieved with a plurality of repeaters, a plurality of edges is installed. However, in configurations that use a repeater, many wireless communication standards only allow a single relay hop. As a result, an edge cannot receive data from sensors that are more than one hop away, and there is a problem that, in configurations in which a plurality of edges is arranged, the operational effort increases.

For example, Japanese Unexamined Patent Publication No. 2018-165099 (Patent Document 1) discloses a wireless communication system that acquires position information of a data collector, position information of a relay device, information relating to a communication status between the data collector and the relay device, and information relating to a communication status between the relay device and a ground unit corresponding to an edge, and based on such information, determines a line-of-sight state between the data collector and the relay device, and controls the position of the relay device such that line-of-sight between the data collector and the relay device is ensured.

### SUMMARY

Furthermore, many sensors used in IoT have limited functionality. In such cases, the sensor may transmit data that has been sensed at a certain, specific timing.

In the wireless communication system described in Patent Document 1, in a case where the data that has been sensed by the sensor is transmitted at a certain, specific timing, because the transmission timing of the sensor is not taken into consideration, the data collector may not be able to receive the information that has been sensed in some cases.

An example object of the present disclosure is to provide a wireless communication system, a wireless communication method, and a program that solve the problem described above.

A wireless communication system according to an example aspect of the present disclosure includes: a receiver configured to be capable of self-propelled movement, perform movement control of the receiver based on a transmission timing of sensing information of a sensor, an installation position of the sensor, and a range in which reception is possible in a case where the sensing information is received from the sensor, and receive the sensing information of the sensor.

A wireless communication method according to an example aspect of the present disclosure is performed by a receiver included in a wireless communication system, the method including the step of: performing movement control of the receiver based on a transmission timing of sensing information of a sensor, an installation position of the sensor, and a range in which reception is possible in a case where the sensing information is received from the sensor, and receiving the sensing information of the sensor.

A non-transitory storage medium storing a program according to an example aspect of the present disclosure is a program for a receiver included in a wireless communication system, the program causing a computer to execute the step of: performing movement control of the receiver based on a transmission timing of sensing information of a sensor, an installation position of the sensor, and a range in which reception is possible in a case where the sensing information is received from the sensor, and receiving the sensing information of the sensor.

### BRIEF DESCRIPTION OF THE DRAWINGS

FIG. 1 is a diagram showing a system overview of a wireless communication system according to an example embodiment of the present disclosure.

FIG. 2A is a functional block diagram showing a configuration of an edge.

FIG. 2B is a functional block diagram showing a configuration of a repeater.

FIG. 2C is a functional block diagram showing a configuration of a human presence sensor.

FIG. 3 is a flowchart relating to processing performed in the wireless communication system in a case where an edge receives data from a human presence sensor via a repeater.

FIG. 4 is a flowchart relating to processing performed in the wireless communication system in a case where an edge receives data from a human presence sensor via a repeater.

FIG. 5 is a flowchart relating to processing performed in the wireless communication system in a case where an edge receives data from a human presence sensor via a repeater.

FIG. 6 is a diagram showing an example of a sensor definition table.

FIG. 7A is a diagram showing an example of a transmission state table.

FIG. 7B is a diagram showing an example of a transmission state table.

FIG. 7C is a diagram showing an example of a transmission state table.

FIG. 8 is a diagram showing an example of a reception history table.

FIG. 9A is a diagram showing an example of a sensor state table.

FIG. 9B is a diagram showing an example of a sensor state table.

FIG. 9C is a diagram showing an example of a sensor state table.

FIG. 10 is a diagram showing an example of a group reading range table.

FIG. 11 is a diagram showing an example showing a state after an edge and a repeater have moved in order to receive data from each human presence sensor in group A.

FIG. 12 is a diagram showing the concept of superimposing rectangular areas that satisfy an RSSI threshold of the human presence sensors belonging to group A, and setting an overlapping section as the optimal reading range of group A.

FIG. 13 is a diagram showing an overview of a wireless communication system in a case where a repeater is not used.

FIG. 14 is a diagram showing an overview of a wireless communication system in a case where two repeaters are used.

FIG. 15 is a diagram showing an example of a sensor state table.

FIG. 16 is a diagram showing an example of a repeater management table.

FIG. 17 is a diagram showing a configuration of a wireless communication system according to an example embodiment of the present disclosure.

FIG. 18 is a diagram showing an example of a hardware configuration of a control unit, such as an edge.

### EXAMPLE EMBODIMENT

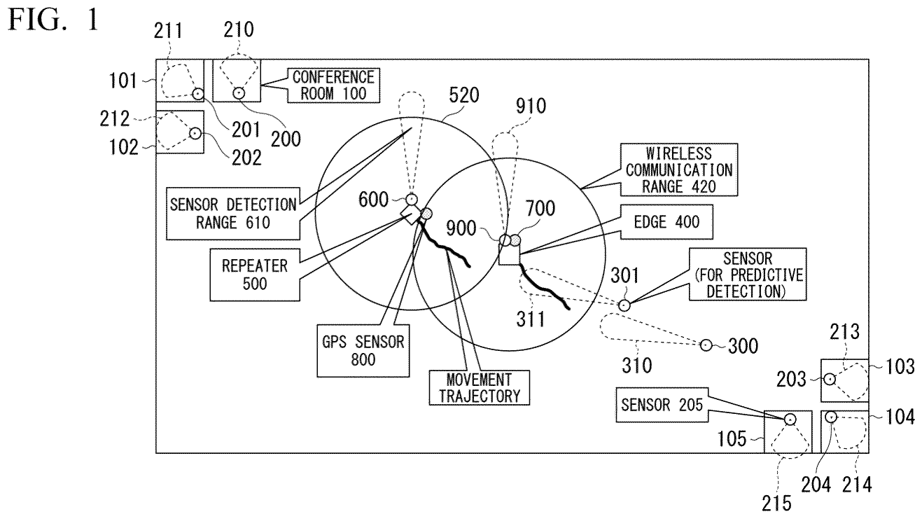

Hereinafter, an example embodiment according to the present disclosure will be described using the drawings. In each of the drawings, the same or corresponding components are assigned the same reference symbols, and common descriptions are omitted. FIG. 1 is a diagram showing a system overview of a wireless communication system according to an example embodiment of the present disclosure. The wireless communication system includes an edge 400 that serves as a receiving device, and a repeater 500. Furthermore, the wireless communication system may include predictive detection human presence sensors 300 and 301. Here, FIG. 1 shows an example in which two predictive detection human presence sensors are shown, but the number of sensors may be one or more.

In FIG. 1, an example of a wireless communication system is shown in which a human presence sensor is installed inside each of a plurality of conference rooms on an office floor in a building of a company or the like, and data from each of the sensors on the large floor is collected using an edge 400 and a repeater 500, which are capable of moving. In the example of FIG. 1, the floor includes conference rooms 100 to 105, and the conference rooms have the respective human presence sensors 200 to 205 installed therein. The human presence sensors have the respective detection ranges 210 to 215. In addition, it is assumed that the repeater 500 is only permitted to perform a single relay hop.

Here, the edge 400 is a device that is capable of self-propelled movement, performs self-propelled movement based on the transmission timing of data, which is sensing information from the human presence sensors 200 to 205, the installation positions of the human presence sensors 200 to 205, and the range in which reception is possible in a case where the sensing information is received from the human presence sensors 200 to 205, and receives the sensing information from the human presence sensors 200 to 205 via the repeater 500. Moreover, the edge 400 is provided with a function that delivers the received sensing information to a line for transmission to a device that processes the sensing information. The edge 400 further includes a Global Positioning System (GPS) 700 and a human presence sensor 900. As a result of the human presence sensor 900 of the edge 400 having a detection range 910, the edge 400 has a wireless communication range 420.

The repeater 500 is equipment that is capable of self-propelled movement under the control of the edge 400, receives the sensing information from the human presence sensors 200 and 205, and relays the received sensing information to the edge 400. The repeater 500 further includes a GPS 800 and a human presence sensor 600. The human presence sensor 600 of the repeater 500 has a detection range 610, and the repeater 500 also has a wireless communication range 520.

The predictive detection human presence sensors 300 and 301 are human presence sensors that are installed in a stationary fashion to the floor on which the conference rooms 100 to 105 are located. The predictive detection human presence sensors 300 and 301 respectively have the detection ranges 310 and 311.

In an example such as that shown in FIG. 1, the edge 400 and the repeater 500 move around the floor while grasping the position information obtained by the respective GPSs 700 and 800, and receive sensing information, which is data from the human presence sensors 200 to 205 installed in the conference rooms 100 to 105. FIG. 1 also shows an example of the movement trajectories in a case where the edge 400 and the repeater 500 move in order to receive data from the human presence sensors 200 to 205 installed in the conference rooms 100 to 105.

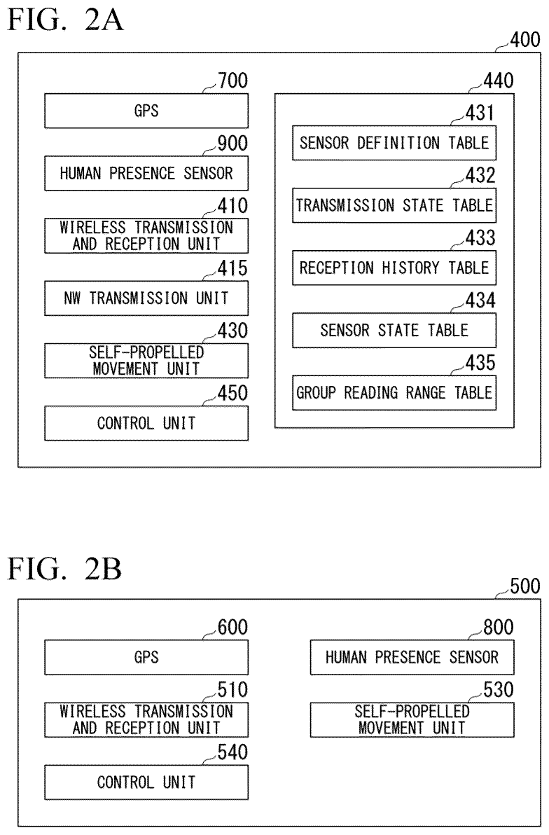

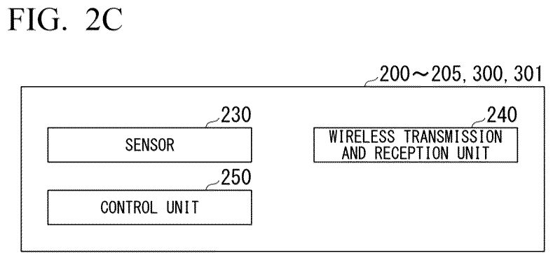

FIG. 2A to FIG. 2C are functional block diagrams showing the configuration of each of the edge 400, the repeater 500, the human presence sensors 200 to 205, and the predictive detection human presence sensors 300 and 301.

As shown in FIG. 2A, the edge 400 includes, in addition to the GPS 700 and the human presence sensor 900, a wireless transmission and reception unit 410, a network (NW) transmission unit 415, a self-propelled movement unit 430, a storage unit 440, and a control unit 450. The wireless transmission and reception unit 410 is provided with the functions of receiving data from the human presence sensors 200 to 205 and the predictive detection human presence sensors 300 and 301 via the repeater 500, and transmitting and receiving information for controlling the movement of the repeater 500 and the like from the edge 400. The NW transmission unit 415 is provided with the function of delivering received data to a line for transmitting the received data to a device that processes the data from the human presence sensors 200 to 205. The self-propelled movement unit 430 is provided with the function of performing self-propelled movement around a floor under the control of the control unit 450, using position information from the GPS 700. The control unit 450, in addition to controlling each device and each unit constituting the edge 400, in order to receive data from the human presence sensors 200 to 205, refers to information provided in the storage unit 440 and the like, and determines the movement position of the edge 400, the movement position of the repeater 500, the time points of the movement to the movement positions, and the like.

The storage unit 440 stores a sensor definition table 431, a transmission state table 432, a reception history table 433, a sensor state table 434, and a group reading range table 435. The sensor definition table 431 is a table for managing the human presence sensors 200 to 205 and the predictive detection human presence sensors 300 and 301, and includes information such as an installation position, an installation location, an installation height, and a data transmission interval of each sensor. The transmission state table 432 is a table for managing the transmission state from the human presence sensors 200 to 205 and the predictive detection human presence sensors 300 and 301, and is used to manage a previous transmission time point of the human presence sensor, a detection result indicating whether or not a person has been detected by the human presence sensor, a predicted next time point of the human presence sensor, and the like. The reception history table 433 is a table for managing the reception status from the human presence sensors, and includes items such as a signal strength at the time of reception from the human presence sensor. The sensor state table 434 is used for management in a case where the human presence sensors are grouped, and for management of the range in which reception of the data is possible from each human presence sensor. The group reading range table 435 is used to manage, with respect to the grouped human presence sensors, the range in which it is possible to simultaneously receive data from all of the human presence sensors included in a group.

As shown in FIG. 2B, the repeater 500 includes, in addition to the GPS 600 and the human presence sensor 800, a wireless transmission and reception unit 510, a self-propelled movement unit 530, and a control unit 540. The wireless transmission and reception unit 510 is provided with the function of receiving data from the human presence sensors, and transmitting the received data to the edge 400. Furthermore, the wireless transmission and reception unit 510 is provided with the function of transmitting and receiving information relating to the movement position and the like with respect to the edge 400 in a case where the repeater 500 moves in order to receive data from the human presence sensors. The self-propelled movement unit 530 is provided with the function of performing self-propelled movement around a floor using control information from the edge 400 and under the control of the control unit 540, and using position information from the GPS 600. The control unit 540 controls the devices and each unit constituting the repeater 500 in order to receive and relay data from the human presence sensors. In addition, the control unit 540 controls the movement of the own device so that the own device stays within a range in which communication is possible with the edge 400.

As shown in FIG. 2C, the human presence sensors 200 to 205 and the predictive detection human presence sensors 300 and 301 include a sensor 230, a wireless transmission and reception unit 240, and a control unit 250. The sensor 230 is an infrared sensor that reacts to the heat and movements of a person, senses a change in temperature in a case where a person passes near the sensor, and outputs a detection result of a person by an on/off signal or the like. The wireless transmission and reception unit 240 is provided with the function of transmitting the sensing information from the sensor 230 as data. In addition, the wireless transmission and reception unit 240 is also provided with the function of receiving control information for the human presence sensor. The control unit 250 controls the devices and each unit constituting the human presence sensor in order to transmit the sensing information from the sensor 230 and the like.

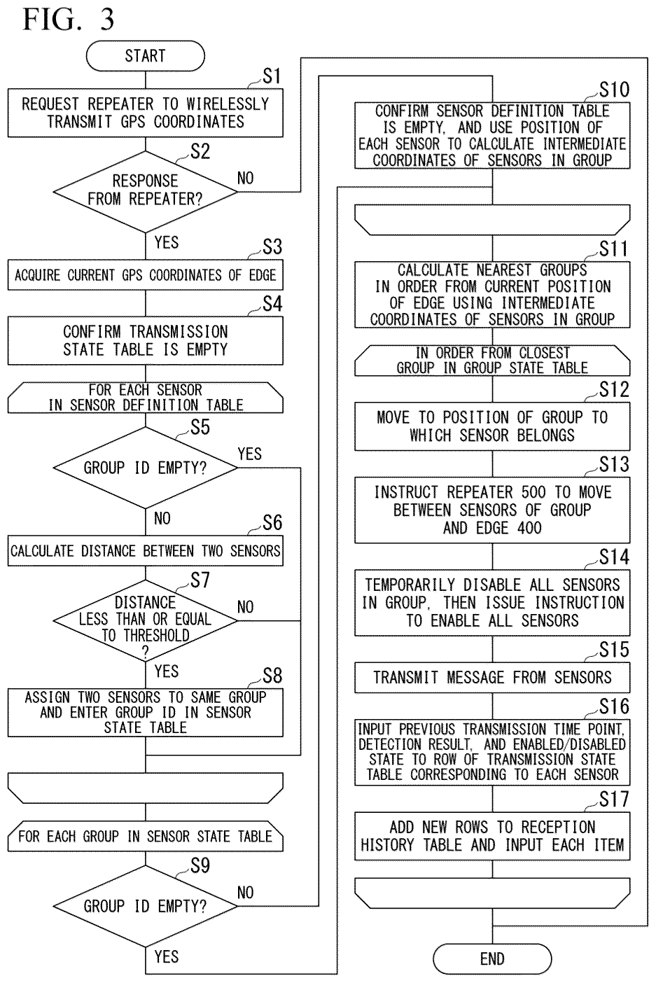

Next, the processing performed by the wireless communication system for receiving data from the human presence sensors will be described. FIG. 3 to FIG. 5 are flowcharts relating to processing performed in the wireless communication system in a case where the edge 400 receives data from the human presence sensors via the repeater 500. The determination processing in the edge 400 and the repeater 500 is performed by the respective control units 450 and 540. However, in the description using FIG. 3 to FIG. 5, in order to simplify the description below, the entity performing the processing will be simply referred to the “edge 400” in a case where referring to the “control unit 450 of the edge 400”, and the “repeater 500” in a case where referring to the “control unit 540 of the repeater 500”.

In FIG. 3, the following operation starts in a case where the edge 400 and the repeater 500 are started.

First, the edge 400 requests the repeater 500 to acquire the GPS coordinates of the repeater 500 (step S1). The edge 400, as a result of obtaining a response that includes the GPS coordinates of the repeater 500 (in step S2: Yes), confirms that the repeater 500 is inside the wireless communication range 420. If there is no response from the repeater (in step S2: No), the edge 400 terminates the processing relating to data reception from the human presence sensors via the repeater 500.

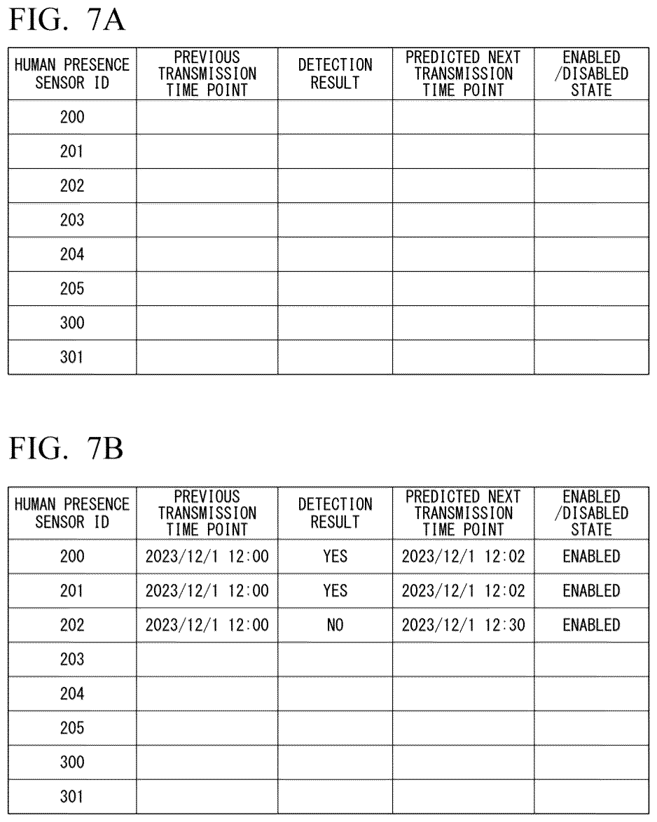

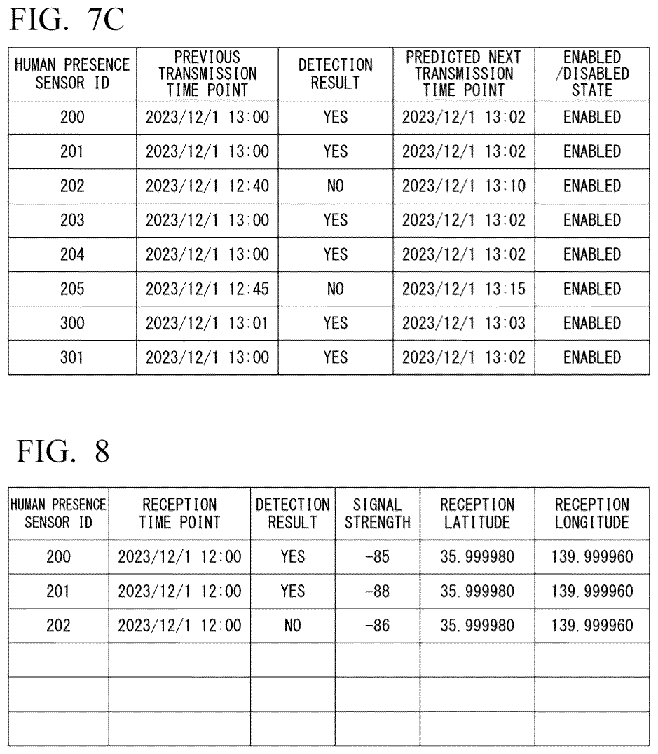

The edge 400 acquires an own position using the GPS 700 (step S3). Furthermore, the edge 400 refers the transmission state table 432, and confirms that the reception information of none of the sensors has been entered in the initial state (step S4). FIG. 7A is a diagram showing an example of the initial state of the transmission state table 432. As shown in the diagram, the transmission state table 432 includes, as items, a human presence sensor ID, a previous transmission time point, a detection result, a predicted next transmission time point, and an enabled/disabled state. The “human presence sensor ID” is an ID that uniquely specifies a human presence sensor that is installed on a floor. Here, a specific ID is set as the “human presence sensor ID” to the human presence sensors 200 to 205 and the predictive detection human presence sensors 300 and 301 that are installed on the floor. The “previous transmission time point” indicates the time point at which the target human presence sensor last transmitted data. The “detection result” indicates a result of whether or not a person has been detected by the human presence sensor. The “predicted next transmission time point” represents the predicted time point of the next transmission by the human presence sensor, which is obtained from the previous transmission time point using the sensor definition table 413 described separately in a case where data is received. The “enabled/disabled state” indicates whether the target human presence sensor is enabled or disabled.

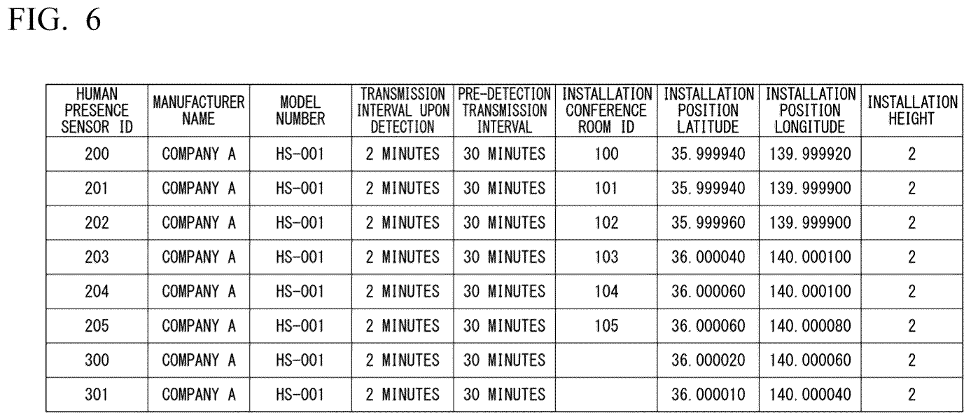

Then, the edge 400 uses the sensor definition table 431 to group the human presence sensors whose installation positions are close to each other (steps S5 to S8). FIG. 6 is a diagram showing an example of the sensor definition table 431. The sensor definition table 431 includes, as items, a human presence sensor ID, a manufacturer name, a model number, a transmission interval upon detection, a pre-detection transmission interval, an installation conference room ID, an installation position latitude, an installation position longitude, and an installation height. The “human presence sensor ID” is an ID that uniquely specifies a human presence sensor that is installed on a floor. The “manufacturer name” and the “model number” represent the manufacturer name and model number of the target human presence sensor. The “transmission interval upon detection” represents the length of the interval before the next data transmission is transmitted after the target human presence sensor detects a person and data relating to the detection result has been transmitted. The “pre-detection transmission interval” represents the length of the interval before the next data transmission is transmitted after data relating to a detection result indicating that the target human presence sensor has not detected a person, has been transmitted. The “installation conference room ID” is an ID that uniquely specifies the conference room in which the target human presence sensor has been installed. The “installation position latitude”, the “installation position longitude”, and the “installation height” represent the latitude and longitude indicating the location where the target human presence sensor has been installed, and the height of the installation position from the floor.

In order to group the human presence sensors, the edge 400 confirms whether or not an ID is set in the “group ID” in the sensor state table 434 for the human presence sensor that is targeted for processing, being a human presence sensor in the sensor definition table 431 (step S5). If an ID is not set (in step S5: No), the edge 400 confirms the position of the target human presence sensor, calculates the distance from the target human presence sensor to the other human presence sensors (step S6), and creates a group with the human presence sensors in which the distance is shorter than a threshold (steps S7 and S8).

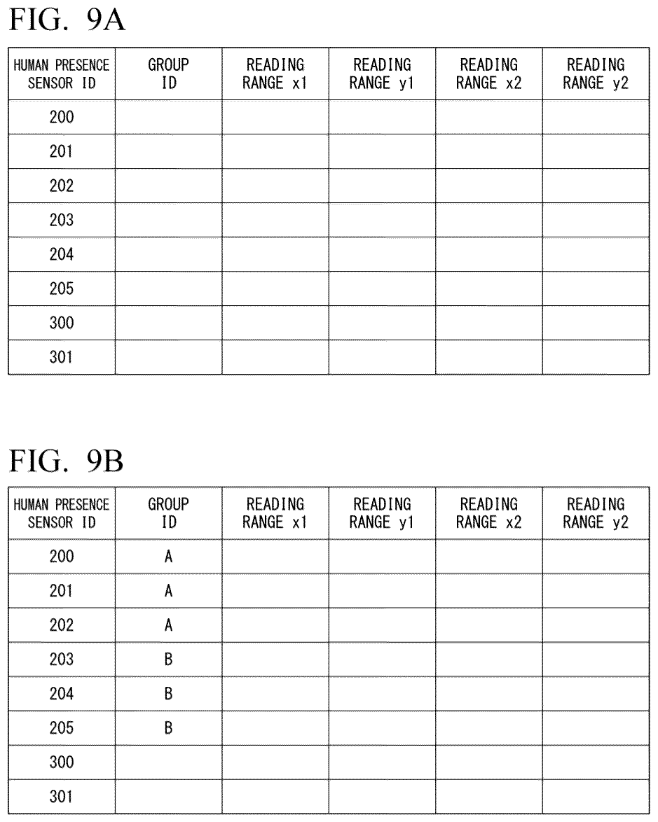

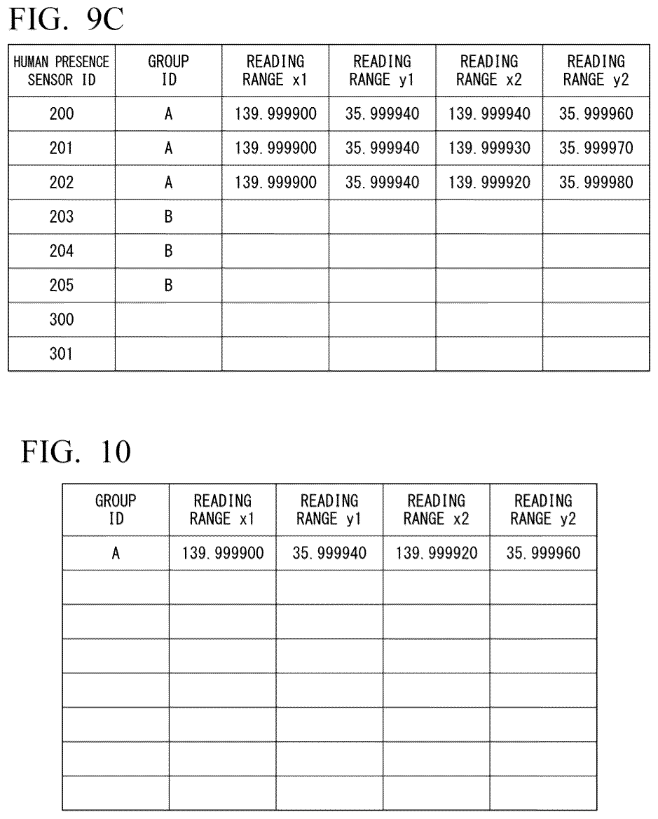

FIG. 9A is a diagram showing an example of the sensor state table 434. The sensor state table 434 includes, as items, a human presence sensor ID, a group ID, a reading range x1, a reading range y1, a reading range x2, and a reading range y2. The “human presence sensor ID” is an ID that uniquely specifies a human presence sensor that is installed on a floor. The “group ID” represents an ID that uniquely specifies a group in a case where the target human presence sensor has been grouped. The “reading range x1”, the “reading range y1”, the “reading range x2”, and the “reading range y2” represent the positions at which data transmitted from the target human presence sensor can be read, that is to say, the range where wireless reception is possible, and is represented by a rectangular area in two-dimensional orthogonal coordinates.

Returning to FIG. 3, for example, in a case where the target human presence sensor is the human presence sensor 200, the distances between the installation position of the human presence sensor 200 and the other sensors are calculated. Then, if the distance is less than or equal to a predetermined value, the same group, such as “group A”, is written to the item “group ID” of the sensor state table 434. In a case where the human presence sensor 203 serves as the target, which is a human presence sensor that is not grouped, the distances to the installation positions of the other sensors that are not grouped are calculated. Then, if the distance is less than or equal to a predetermined value, the same group, such as “group B”, is written to the item “group ID” of the sensor state table 434. The edge 400 does not subject the predictive detection human presence sensors 300 and 301 to grouping. In the example of FIG. 1, two groups are defined, namely the human presence sensors 200 to 202 as group A, and the human presence sensors 203 to 205 as group B, and then the group IDs are entered in the sensor state table 434. The sensor state table 434 at this time is shown in FIG. 9B.

The edge 400 determines the movement order into the group that has been grouped (steps S9 to S11). The edge 400 refers the sensor definition table 431 and the sensor state table 434, and calculates an intermediate coordinate position from the positions of the human presence sensors belonging to the same group (step S10). The edge 400 performs the processing (step S10) with respect to all of the groups defined in the sensor state table 434 (steps S9 and S10). The edge 400 determines the order of groups starting with the group that is closest to the edge 400, based on the calculated intermediate coordinate position of each group and the current position of the edge 400 (step S11). In the example of FIG. 1, it is assumed that it is calculated that group A is the closest, and group B is the next closest.

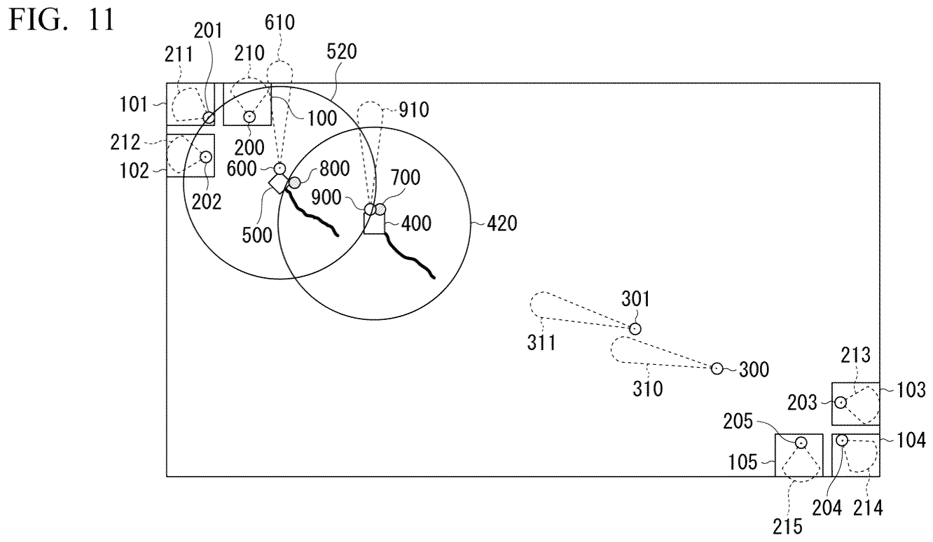

The edge 400 uses the sensor state table 434 and the sensor definition table 431 to confirm the location of group A, which is the closest group from the current position of the edge 400, and moves close enough to group A to receive data (step S12). At this time, the edge 400 issues a movement instruction to the repeater 500, and in a case where data is simultaneously received from the human presence sensors in group A, causes the repeater 500 to move inside the wireless communication range 420, in which the edge 400 can receive signals via the repeater 500, to a position between the human presence sensors in group A and the edge 400, such that the movement distance of the edge 400 is minimized (step S13). In the processing (step S12) and the processing (step S13), if there are no obstacles on the floor, the edge 400 calculates the movement position of the repeater 500, and further, the movement position of the edge 400 on a direct line or in the vicinity of a direct line that connects the current position of the edge 400 that has been calculated in the processing (step S10) and the intermediate coordinate position of group A. The movement position of the repeater 500 is a position that can cover the transmission range of all of the human presence sensors belonging to group A. It is assumed that the transmission range of each human presence sensor in group A is set to an initial value that enables reception by the repeater 500. Furthermore, the movement position of the edge 400 is a range that enables the edge 400 to perform transmission and reception with respect to the repeater 500. FIG. 11 is a diagram showing an example showing a state after the edge 400 and the repeater 500 have moved in order to receive data from each human presence sensor in group A. If there is an obstacle on the floor, the edge 400 determines the movement positions of the edge 400 and the repeater 500 after taking the position of the obstacle into account.

After the edge 400 and the repeater 500 have moved to the movement positions, the edge 400 issues an instruction by a network communication that sets the enabled or disabled state of each sensor in group A. That is to say, the edge 400 transmits, to each sensor in group A via the repeater 500, an instruction that temporarily disables and then re-enables the human presence sensor that is the reception target (step S14). As a result, in a case where the sensors in group A have performed a detection operation, in the initial stage, it becomes possible to receive data from each sensor via the repeater 500 with the same timing (step S15). As a result of such an operation, it subsequently becomes possible for the human presence sensors 200 to 202 belonging to group A to transmit data in such a cycle. Although an example has been shown here where the setting of the human presence sensors to enabled or disabled is performed with an instruction issued by a wireless communication, it is not limited to this. For example, a direct mechanism may be implemented in which the repeater 500 presses a switch to switch the human presence sensor 200 to enabled or disabled in response to an instruction from the edge 400.

In a case where the edge 400 receives a packet containing data relating to sensing information from the human presence sensor that includes whether or not a person has been detected, the edge 400 inputs, as each of the previous transmission time points, the detection result, and the enabled/disabled state in the rows of the transmission state table 432 containing the sensor IDs 200, 201, and 202, and values corresponding to the current time point, whether or not detection has occurred, and been enabled. At this time, if the value indicating whether or not detection has occurred in the packet that has been received from the human presence sensor is “yes”, the edge 400 inputs, as the predicted next transmission time point, a time point obtained by adding the value of the transmission interval upon detection to the previous transmission time point (step S16). If the value indicating whether or not detection has occurred is “no”, the edge 400 inputs, as the predicted next transmission time point, the value obtained by adding the pre-detection transmission interval to the current time point (step S16). For example, in the transmission state table 432 shown in FIG. 7B, in a case where a person has been detected by the human presence sensors 200 and 201, a time point obtained by adding 2 minutes, which corresponds to the “transmission interval upon detection” of the human presence sensors 200 and 201 shown in the sensor definition table 431, to the previous transmission time point “2023/12/1 12:00”, is recorded as the predicted next transmission time point “2023/12/1 12:02” of the human presence sensors 200 and 201 in the transmission state table 432. Similarly, in a case where a person has not been detected by the human presence sensor 202, a time point obtained by adding 30 minutes, which corresponds to the “pre-detection transmission interval” of the human presence sensor 202 shown in the sensor definition table 431, to the previous transmission time point “2023/12/1 12:00”, is recorded as the predicted next transmission time point “2023/12/1 12:30” of the human presence sensor 202 in the transmission state table 432.

In addition, new rows are added to the reception history table 433, and in each item, namely the human presence sensor ID, the reception time point, the detection result, the signal strength, the reception latitude, and the reception longitude, the values of 200 (or 201 or 202), the time point at which reception occurred, whether or not detection has occurred, the signal strength value, and the latitude and longitude of the repeater at the time of reception, are stored (step S17). FIG. 8 is a diagram showing the reception history table 433 at this time. As shown in FIG. 8, the reception history table 433 includes, as items, a human presence sensor ID, a reception time point, a detection result, a signal strength, a reception latitude, and a reception longitude. The “human presence sensor ID” is an ID that uniquely specifies a human presence sensor that is installed on a floor, and is the ID of the human presence sensor in a case where data is received from the target human presence sensor. The “detection result” indicates whether or not a person has been detected by the target human presence sensor. The “signal strength” indicates the signal strength in a case where the repeater 500 receives data from the target human presence sensor. The “reception latitude” and the “reception longitude” indicate the latitude and longitude of the position of the repeater 500 in a case where data is received from the target human presence sensor.

The edge 400 performs the processing of steps S12 to S17 in order to receive data from the human presence sensor of group B, which has the next closest distance after group A. Thereafter, the same processing is repeated with respect to other groups. However, the processing of steps S12 to S17 is not performed with respect to the sensors for predictive detection. This is because information relating to the timing at which detection occurs in the sensors for predictive detection is utilized, and therefore, if the timing is controlled by the edge 400, the sensors for predictive detection cannot be used as intended.

Then, the repeater 500 and the edge 400 confirm the predicted next transmission time point for each group using the transmission state table 432, move to the group targeted for data reception in a case where the predicted next transmission time point approaches, and read the data from the human presence sensors belonging to the group. The operation performed at the time of reading is the same as steps S16 and S17.

As the edge 400 repeatedly moves to the group that is the data reception target, and simultaneously reads data from the human presence sensors belonging to the group, it becomes increasingly difficult to efficiently read the data all at once due to variations in the predicted next transmission time point of the sensors in the group, depending on whether or not a person has been detected by the sensors belonging to the group. In such a case, the edge 400 executes the adjustment of the transmission timing (step S14) again. The criteria for determining that variation exist may be, for example, (1) in a case where three or more patterns exist in the predicted next transmission time points of the sensors in the group, or (2) in a case where data reception from the sensors belonging to a different group creates a temporal conflict in a case where the movement of the repeater 500 and the edge 400 is considered, leading to a status in which reception is not possible.

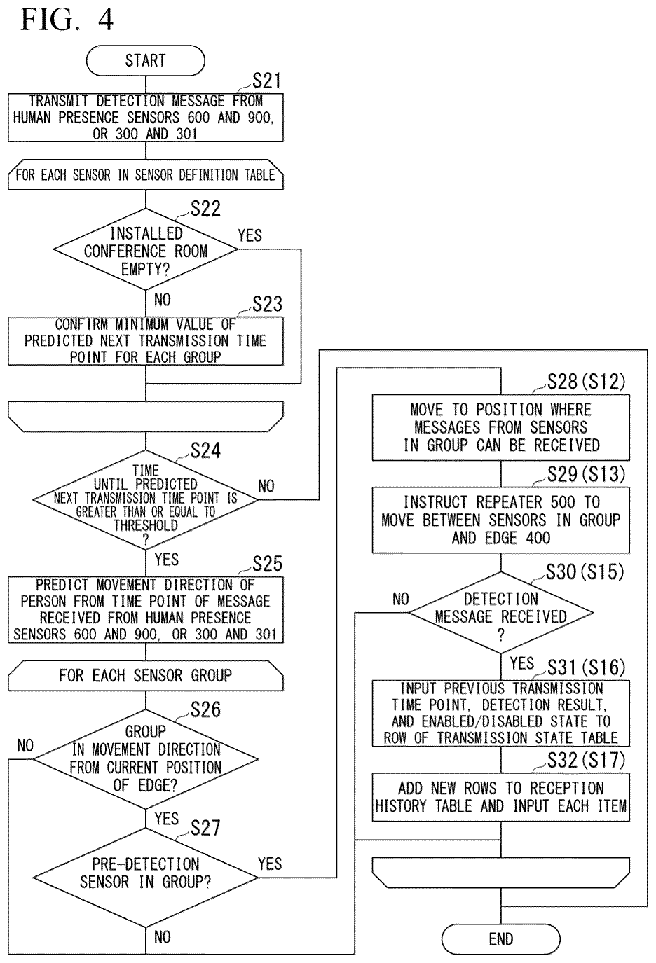

The repeater 500 and the edge 400 successively determine the order of the groups based on the distance from the edge 400 and the predicted next transmission time points of the human presence sensors belonging to the group, and repeatedly execute steps S12, S13, S15 to S17, and S14 as necessary, while also circulating the floor in a case where idle. At this time, if the human presence sensor 900 or 600 attached to the edge 400 or the repeater 500 detects a moving person, or if data is received from the predictive detection human presence sensors 300 and 301, which indicates that a moving person has been detected, the edge 400 estimates the direction in which the person is moving, and performs processing that receives data from the human presence sensors 200 to 205 that are in the estimated direction. That is to say, if there is a sensor in a pre-detection state and an enabled state, which is in the direction that a person is moving that can be estimated from 1) the installation positions and detection times of the predictive detection human presence sensors 300 and 301, and/or 2) the position and detection time of the edge 400 and/or repeater 500 in a case where the human presence sensor 900 or 600 attached to the edge 400 and/or repeater 500 detects a person, and there is time until the data reception timing from each group, the repeater 500 and the edge 400 move in the movement direction of the person, and the edge 400 confirms whether or not the sensors in the pre-detection state switch to the detection state, that is to say, whether or not to receive detection data. The processing according to steps S16 and S17 is performed if data is received. FIG. 4 is a diagram showing the processing performed to estimate the movement direction of a person as described above, and to receive data from the human presence sensors 200 to 205 in the movement direction. For example, as shown in the transmission state table 432 in FIG. 7, an example will be described of a case where the predictive detection human presence sensors 300 and 301 have detected a person.

The edge 400 acquires/receives human detection data from the predictive detection human presence sensors 300 and 301 and/or the human presence sensors 900 and 600 attached to the edge 400 and/or the repeater 500 (step S21).

The edge 400 refers to the transmission state table 432 and the sensor state table 434, and for each group, if the most recent detection result of any of the human presence sensors belonging to the group is “yes”, that is to say, if the conference room in which the human presence sensor is installed is not empty, detects the nearest time point among the “predicted next transmission time points” of the sensors belonging to the group (steps S22 and S23).

If the difference between the nearest time point among the “predicted next transmission time point” determined for each group and the current time point is not greater than or equal to a predetermined value (in step S24: No), the edge 400 terminates the movement processing of the edge 400 and the repeater 500 based on the movement prediction of a person.

On the other hand, if the difference between the nearest time point among the “predicted next transmission time point” determined for each group and the current time point is greater than or equal to the predetermined value (in step S24: Yes), the edge 400 predicts the movement direction of the detected person from the position and time of the edge 400 and the repeater 500 in a case where the edge 400 acquires/receives human detection data from the predictive detection human presence sensors 300 and 301 and/or the human presence sensors 900 and 600 attached to the edge 400 and/or the repeater 500 (step S25). In the example of the transmission state table 432 in FIG. 7C, because the predictive detection human presence sensor 301 detects the person after the predictive detection human presence sensor 300 detects the person, the edge 400 predicts that the person is moving from the installation position of the predictive detection human presence sensor 300 toward the reporting by the predictive detection human presence sensor 301.

The edge 400 refers to the sensor definition table 431 and the sensor state table 434, and determines whether or not there is a human presence sensor group in the predicted direction. If there is no group (in step S26: No), the edge 400 terminates the movement processing of the edge 400 and the repeater 500 based on the movement prediction of a person.

On the other hand, if there is a group in the predicted direction (in step S26: Yes), the edge 400 further refers to the transmission state table 432, and confirms whether or not the most recent detection result of any of the human presence sensors belonging to the group is “no”, that is to say, whether or not there is an available conference room (step S27). If there are no available conference rooms (in step S27: No), the edge 400 determines that the person moving in the predicted direction is not moving for the purpose of using an available conference room, and terminates the movement processing of the edge 400 and the repeater 500 based on the movement prediction of a person.

On the other hand, if there is an available conference room (in step S27: Yes), the edge 400 and the repeater 500 move in order to receive data from the human presence sensors in the group that is in the predicted direction (steps S28 and S29), and receive the data (step S30). The processing (steps S28 to S30) is the same as the processing of each of the processing (steps S12, S13, and S15) in FIG. 3. If any of the human presence sensors belonging to the group detect the person (in step S30: Yes), the edge 400 performs the same processing as each of the processing (step S16 and S17) in FIG. 3. If none of the human presence sensors belonging to the group detect the person (in step S30: No), the edge 400 terminates the movement processing of the edge 400 and the repeater 500 based on the movement prediction of a person.

In a case where the movement processing of the edge 400 and the repeater 500 due to the movement prediction of a person is terminated, the edge 400 repeats the simultaneous reading of data from the human presence sensors belonging to the group described in FIG. 3. In this way, the edge 400 performs movement processing of the edge 400 and the repeater 500 based on the movement prediction of a person.

In addition, the edge 400 may adjust the range in which data can be received from the human presence sensors belonging to a group by utilizing the radio wave strength in a case where the repeater 500 receives data from the human presence sensors. As a premise of the processing, in a case where the edge 400 receives data from the human presence sensors in step S15 of FIG. 3 or step S30 of FIG. 4, it is assumed that a radio wave strength (RSSI: Received Signal Strength Indicator) value in a case where the repeater 500 receives the data, and the latitude and longitude of the repeater 500 at the time of reception are successively recorded in the reception history table 433. FIG. 8 is a diagram showing an example of the reception history table 433. In the table, the item “signal strength” indicates the value of the radio wave strength (RSSI) in a case where the repeater 500 receives the data. From the records in the reception history table 433, the edge 400 determines and updates the range in which the edge 400 can receive data via the repeater 500 from each sensor, and therefore, from each group, as needed.

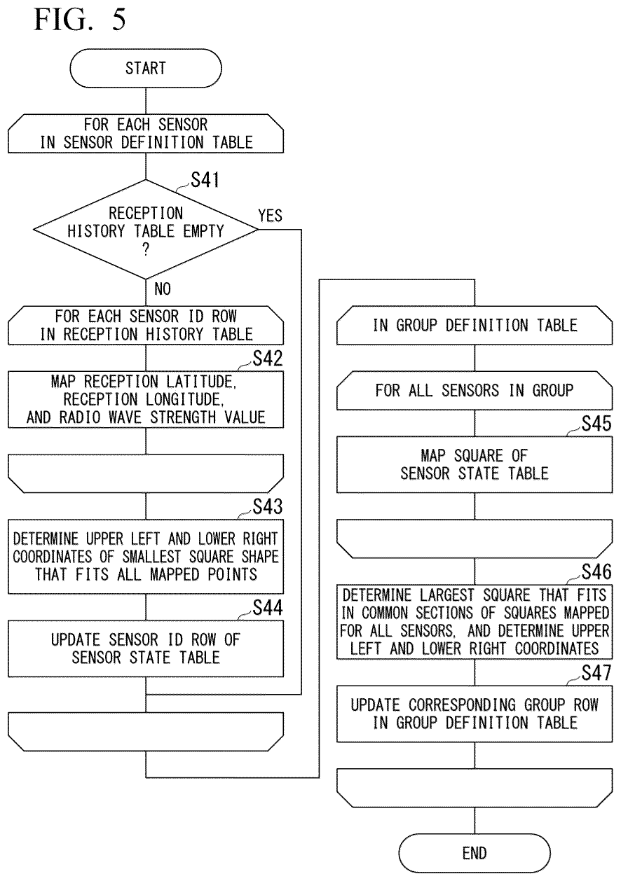

FIG. 5 is a diagram showing the processing performed in a case where the edge 400 uses the radio wave strength to adjust the range in which data can be simultaneously received from the human presence sensors belonging to a group. If the target human presence sensor is not empty in the reception history table 433 (in step S41: No), the edge 400 maps, for each human presence sensor, the latitude and longitude of the repeater 500 at the time of reception from the human presence sensor, and the RSSI value at the time (step S42). The edge 400 calculates a range that satisfies a predetermined RSSI threshold for the mapping result (step S43), and adds the result to the sensor state table 434 (step S44). FIG. 9C shows an example in which the range satisfying the conditions for each human presence sensor is represented by a rectangular area using the latitude and longitude in the sensor state table 434.

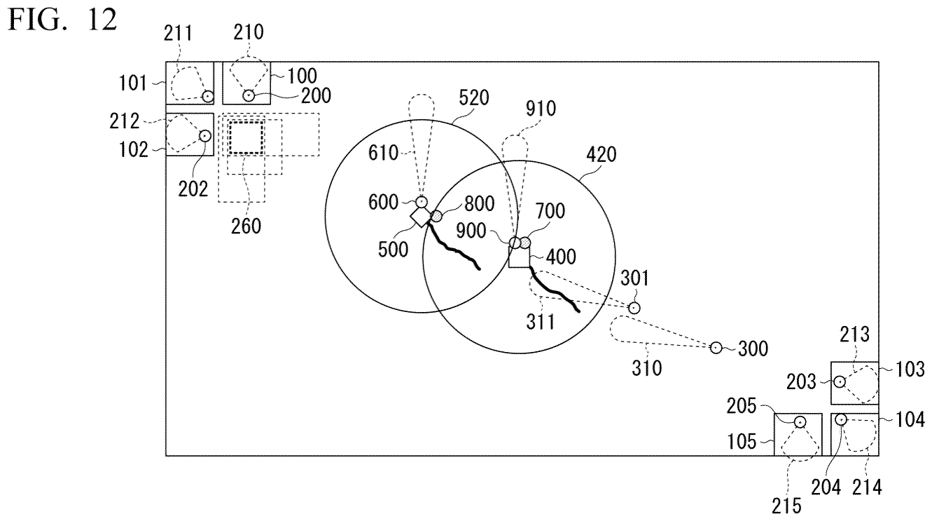

The edge 400 superimposes the results of each group (step S45), determines the range of the common sections as the optimal reading range of the group (step S46), and inputs the range into the group reading range table 435 (step S47). FIG. 10 is a diagram showing an example of the group reading range table 435. In FIG. 10, an example is shown in which the range in which the repeater 500 can reliably simultaneously receive data from all the human presence sensors belonging to group A is defined as a rectangular area using a latitude and longitude. FIG. 12 is a diagram showing an image in a case where rectangular areas that satisfy an RSSI threshold of the human presence sensors 200 to 202 belonging to group A are superimposed and define a common section 260 as the optimal reading range of group A.

In a case where the edge 400 and the repeater 500 receive data from the sensors in each group, the repeater 500 refers to the group reading range table 435, moves inside the optimal read range indicated in the group reading range table 435, and receives the data. Furthermore, the edge 400 updates the optimal read range as appropriate. The calculation of the optimal read range is approximated as a rectangular area as an example, but it is not limited to this.

The edge 400 updates the group reading range table 435 as described above.

As described above, the edge 400 and the repeater 500 are not installed in a fixed manner, but are capable of moving by being mounted on, for example, a drone, an Automated Guided Vehicle (AGV), an Autonomous Mobile Robot (AMR), or the like. In a case where the timing approaches for a human presence sensor that is installed far away to transmit data, the edge (or the repeater) moves toward the human presence sensor, and returns to the original position after receiving the data. At this time, the edge 400 transmits the data to the cloud using a wireless network line such as a carrier line. The repeater 500 relays communication between the human presence sensors and the edge 400, and the human presence sensors periodically transmit data. In addition, the edge 400 and the repeater 500 are each able to learn the position of the other using a GPS, and are capable of exchanging information inside the wireless communication range. As a result, the edge 400 controls the repeater 500, and moves the repeater 500 to a position where data can be relayed for the collection of data from the human presence sensors.

At this time, the edge 400 performs the following as a mechanism of knowing the timing at which the human presence sensors transmit data.

The edge 400 or the repeater 500 manages the data transmission period and status of the human presence sensors in a list, and predicts the timing at which data is next transmitted based on the operation specifications of the human presence sensors. Furthermore, as the number of sensors increases and the arrangement becomes dispersed, a state may arise in which sensors at a plurality of distant locations each transmit data simultaneously. In order to prevent such a state, the edge 400 or the repeater 500 controls the data transmission timing to be as close as possible to that of other nearby sensors inside the same communication area, such as by temporarily turning off the power supply connected to the sensors, or by temporarily rotating the sensors toward a wall to disable sensing, even if the sensors would normally be in a state to perform detection and transmit data. This is achieved by the edge 400 performing a control using wireless communication, or by the repeater 500 physically operating the sensors. As a result, the edge 400 or the repeater 500 is able to receive data from a plurality of sensors that are locally concentrated at the same timing, and enables data to be received evenly from a plurality of sensors that are arranged in a dispersed manner in distant locations while locally shifting the timing.

In addition, the boundaries of the range in which the data transmitted by each human presence sensor can be efficiently received are calculated based on statistical values of the radio wave strength included in the data received from each human presence sensor, and the distance that the edge 400 or the repeater 500 moves in order to receive the data is minimized, which makes the movement more efficient.

Also, another predictive detection human presence sensor is placed closer to the edge 400 and the repeater 500, than the more distant target human presence sensor, and data from the predictive detection human presence sensor is collected to determine whether or not the more distant human presence sensor is likely to transmit data. For example, if the predictive detection human presence sensor installed in front of the human presence sensor that is targeted for data acquisition responds, the focus can be narrowed in that there is a possibility that a person will approach the target position. Further, in a case where a plurality of predictive detection human presence sensors are used, the movement of a person can be predicted with even greater accuracy by utilizing a time lapse of the detection by the predictive detection human presence sensors. Alternatively, a human presence sensor can be attached to the body of the edge 400 or repeater 500, and the detection content can be monitored while moving around to predict whether or not the target human presence sensor will transmit data. As an example, if a human presence sensor is attached to the edge 400 or the repeater 500, and a person is detected near the target sensor while moving, it is estimated that there is a possibility that the target sensor will detect the person.

Therefore, in a wireless communication system in which the edge 400 receives data transmitted by human presence sensors via wireless communication, even in a case where the human presence sensors are located at distances where wireless communication is normally unreachable, reception is possible by moving the edge 400. As a result, the range covered by the wireless communication system can be expanded without being restricted by the wireless communication range. In addition, data from the human presence sensors can be efficiently received.

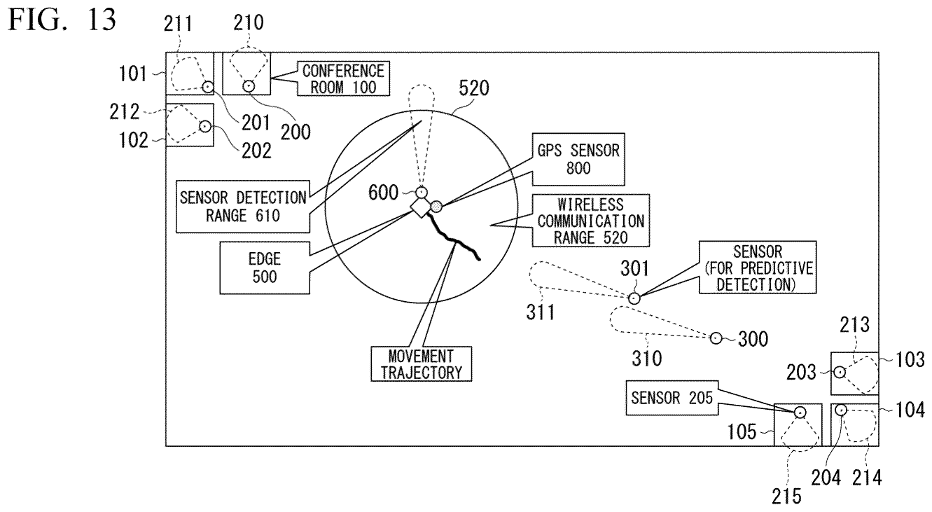

An example embodiment of the present disclosure has a configuration in which the edge 400 is the center of processing, and performs processing such as predicting the timing of data transmission from the time sensors and adjusting the timing, and the repeater 500 moves significantly in order to support the data reception from the sensors. In another example embodiment, the repeater 500 may not be used, and a single edge 400 may perform all of the various processing up to receiving data from the sensors. FIG. 13 is a diagram showing an overview of a wireless communication system in a case where a repeater 500 is not used. FIG. 13 differs from FIG. 1 only in that the repeater 500 is not present. The operation of the edge 400 at this time differs only in that the repeater 500 does not relay data from the human presence sensors, and the edge 400 moves in a manner equivalent to that of the repeater 500. In this case, although the repeater 500 is not required, the distance that the edge 400 must travel is increased due to the absence of the repeater 500. Therefore, there is a possibility that the applicable range may be relatively smaller than that of the example embodiment.

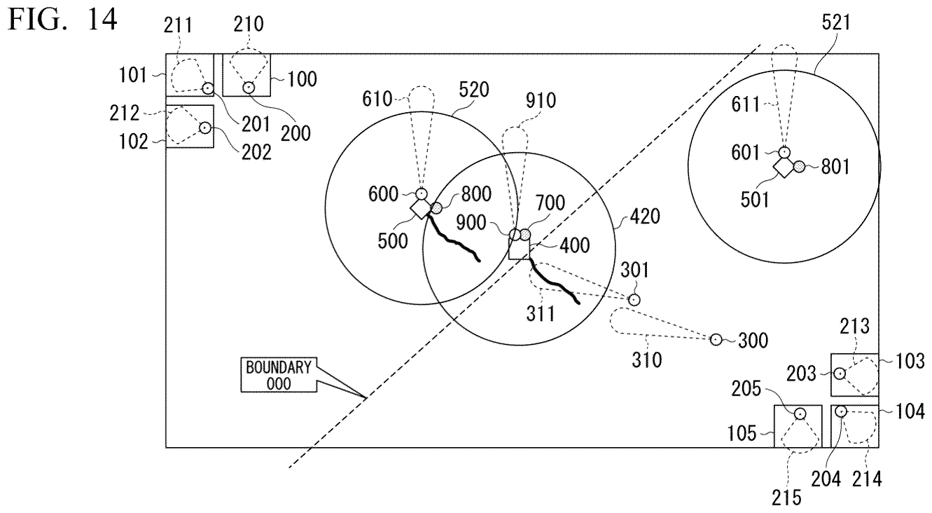

Furthermore, in the example embodiment of the present disclosure, a single repeater 500 and single edge 400 are used. However, as another example embodiment, a configuration is possible in which two or more repeaters are used. FIG. 14 is a diagram showing an overview of a wireless communication system in a case where two repeaters are used. As the number of repeaters increases, the present disclosure can be implemented over a wider area.

A case where a plurality of repeaters are used will be described. The area in which the example embodiment described above is applied is logically divided by the number of repeaters, where a repeater is assigned to each area, and the repeater manages data reception from the sensors in the assigned area. For example, in a configuration using two repeaters 500 and 501 as in FIG. 14, the target area in which the example embodiment described above is applied is divided into two, and the repeaters 500 and 501 are each assigned to the right side and the left side. Each repeater moves to the sensors arranged inside the assigned area, and relays the data such that the edge 400 is capable of receiving data from distant sensors with only a small movement. The example of FIG. 14 shows an example where the repeater 500 is assigned to the human presence sensors 200 to 202, and the repeater 501 is assigned to the human presence sensors 203 to 205.

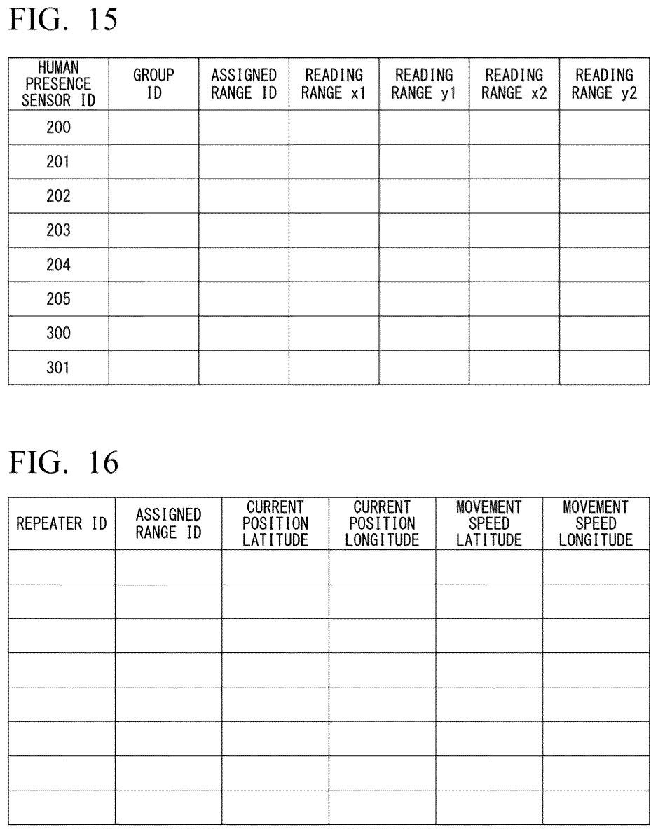

Some wireless communication protocols do not allow multiple relays. Alternatively, there is a possibility that the repeaters may continue to repeatedly relay data between each other, causing congestion. Therefore, in a case where the edge 400 moves each of the repeaters within the assigned area, the edge 400 controls the repeaters to not come closer to each other than the radius of the wireless communication range. Specifically, at the timing of grouping the human presence sensors described in the processing of S5 to S8 of FIG. 3, the edge 400 calculates the distance between the groups from the coordinates of the groups, and draws a boundary line as a divided block for a set of groups where the distance is less than or equal to a threshold value. Also, in a case where adjusting the transmission timing of the human presence sensors, the edge 400 performs a control that offsets the time such that the repeaters do not gather at groups having nearby coordinates at a near time point, but in a different allocated area. Also, the edge 400 performs distance calculations and path control to ensure that, in a case where the repeaters are circulating or moving, the repeaters do not get closer to each other than the radius of the wireless communication range. Each edge 400 uses the sensor state table and the repeater management table in a case where performing such processing. FIG. 15 and FIG. 16 are diagrams respectively showing a sensor state table and a repeater management table. In the sensor state table shown in FIG. 15, compared to the sensor state table 434 shown in FIG. 9A to 9C, an “allocation area ID” is added as an item. The item “allocation area ID” indicates the result of summarizing the groups according to the distance between the groups, and serves as an ID that indirectly specifies the repeater that receives data from a target human presence sensor. The repeater management table shown in FIG. 16 includes, as items, a repeater ID, an allocation area ID, a current position latitude, a current location longitude, a movement speed latitude, and a movement speed longitude. Here, the “current position latitude” and the “current speed longitude” are items that indicate the current position of the target repeater using a latitude and longitude. The “movement speed latitude” and the “movement speed longitude” indicate, using a latitude and longitude, the position to which the target repeater is scheduled to move from the “current location latitude” and the “current location longitude” after a predetermined time unit. The edge 400 updates the sensor state table and the repeater management table described above, while also performing a control that offsets the time such that repeaters do not gather at a group having nearby coordinates at a near time point, but a different allocated area, and also performs distance calculations and path control to ensure that, in a case where the repeaters are circulating or moving, the repeaters do not get closer to each other than the radius of the wireless communication range.

In the example embodiment of the present disclosure, a human presence sensor is used as an example of data collection in IoT. However, the present disclosure is not limited to this. Another type of IoT sensor may be used.

Furthermore, in the example embodiment of the present disclosure, the edge 400 executes various processing. However, the repeater 500 may be provided with such a function.

The wireless communication system of the present disclosure can be used in cases where a large number of inexpensive sensors are installed over a vast area. In addition to visualizing the usage status of conference rooms as described in the example embodiment of the present disclosure, application is also possible in cases where IoT is utilized in offices or factories, for example, in remote maintenance of equipment, and management of facilities. Furthermore, the present disclosure can also be applied to improve the efficiency of work utilizing IoT at large-scale construction sites such as building sites and mining sites, that is to say, visualizing the state of workers, grasping the status of machines and robots, and performing maintenance. Also, the wireless communication system of the present disclosure can also be applied to collecting status data using IoT over a vast area, such as for environmental conservation of forests, living things, and rivers.

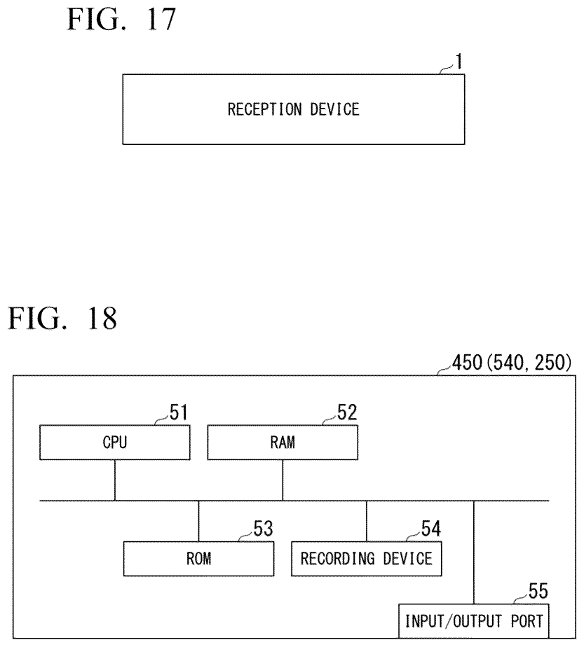

FIG. 17 is a diagram showing a configuration example of a wireless communication system according to an example embodiment of the present disclosure. The wireless communication system includes: a reception device that is capable of self-propelled movement, performs movement control of an own device based on a transmission timing of sensing information of a sensor, an installation position of the sensor, and a range in which reception is possible in a case where the sensing information is received from the sensor, and then receives the sensing information of the sensor.

FIG. 18 is a block diagram showing an example of a hardware configuration of the control units 450, 540 and 250 of the edge 400, the repeater 500, and the human presence sensor. Here, the hardware configuration of the control unit includes a CPU 51, a Random Access Memory (RAM) 52, a Read Only Memory (ROM) 53, a recording device 54, and the like. The ROM 53 and the recording device 54 store programs and information that realize the functions of the control unit. The RAM 52 is used as a work area that temporarily stores the data used during operation of the CPU 51 and the like. Furthermore, the control unit also includes an input/output port 55 that serves as an interface for connecting to other devices, the edge 400, the repeater 500, and devices that constitute the human presence sensor. The ROM 53 may be configured by an Electrically Erasable Programmable Read-Only Memory (EEPROM) or the like. In addition, the recording device 54 may be configured by a hard disk, an SSD, or the like. The computer program for realizing the functions of the control unit may be updated in the ROM 53 or the recording device 54. In some cases, only the ROM 53 is provided in the control unit 250 of the human presence sensor, and the recording device 54 is omitted.

The present disclosure has been described above with reference to the example embodiments. However, the present disclosure is not limited to the example embodiments described above. Various changes to the configuration and details of the present disclosure that can be understood by those skilled in the art can be made within the scope of the present disclosure. In addition, each of the example embodiments may be combined as appropriate with other example embodiments.

According to an example aspect described above, even in a case where information that has been sensed by a sensor is transmitted with a certain, specific timing, it is possible to receive the information that has been sensed.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

A part or all of the example embodiment described above can be written as in the supplementary notes below, but is not limited thereto.

### (Supplementary Note 1)

A wireless communication system including:
a reception device that is capable of self-propelled movement, performs movement control of an own device based on a transmission timing of sensing information of a sensor, an installation position of the sensor, and a range in which reception is possible in a case where the sensing information is received from the sensor, and then receives the sensing information of the sensor.

### (Supplementary Note 2)

The wireless communication system according to supplementary note 1, wherein
the wireless communication system further includes a repeater that is capable of self-propelled movement, that receives the sensing information from the sensor, and relays the received sensing information to the reception device,
the reception device being a device that is capable of transferring the received sensing information to a data processing system, and
the reception device
further performs movement control of the repeater based on a transmission timing of the sensing information of the sensor, the installation position of the sensor, and a range in which reception is possible in a case where the repeater receives the sensing information from the sensor, and
receives the sensing information of the sensor via the repeater.

### (Supplementary Note 3)

The wireless communication system according to supplementary note 2, wherein
the reception device performs movement control of the repeater such that an own movement distance is minimized in a position where transmission and reception is possible with respect to the repeater, and in a case where the sensing information is received from the sensor via the repeater.

### (Supplementary Note 4)

The wireless communication system according to supplementary note 2 or 3, wherein
the reception device
performs grouping in a case where there are a plurality of sensors, where the plurality of sensors are grouped in a group that causes a distance between each sensor from an installation position of each sensor to be less than or equal to a predetermined value, and
performs movement control of the repeater such that the repeater can receive the sensing information at a predetermined time point from all of the sensors included in the group.

### (Supplementary Note 5)

The wireless communication system according to supplementary note 4, wherein the reception device
predicts, for each sensor, a time point at which the sensor next transmits the sensing information based on a reception time of the last received sensing information, and
in a case where it is determined that, based on the predicted next time point at which the sensing information is transmitted, it is not possible to receive the sensing information from all of the sensors included in the group at a predetermined time point, performs a control that causes all of the sensors included in the group to be temporarily disabled, and then enabled.

### (Supplementary Note 6)

The wireless communication system according to supplementary note 4 or 5, wherein
the wireless communication system includes a plurality of repeaters, and
the reception device
performs further grouping of the group based on position information of the group and the number of repeaters, and then assigns a repeater to each group that has been further grouped, and
in a case where the sensing information is received from a sensor belonging to a predetermined group, performs movement control of a repeater that has been assigned to a group that has been further grouped, to which the predetermined group belongs, and receives the sensing information of the sensor that belongs to the predetermined group via the repeater with respect to which movement control has been performed.

### (Supplementary Note 7)

The wireless communication system according to any one of supplementary notes 4 to 6, wherein
the reception device adjusts the range in which reception is possible in a case where the repeater receives the sensing information from all of the sensors belonging to the group based on a reception strength in a case where the repeater receives the sensing information from the sensor.

### (Supplementary Note 8)

The wireless communication system according to any one of supplementary notes 2 to 7, wherein
the sensor is a human presence sensor,
the wireless communication system is provided with a plurality of predictive detection human presence sensors that are different from the sensor, and are installed in a fixed manner in order to perform movement detection prediction of a person, and/or
the repeater and the reception device are each provided with a human presence sensor,
the reception device
predicts a movement direction of a person based on a time point at which a person is detected by the predictive detection human presence sensor, and an installation position of the predictive detection human presence sensor, and/or based on a time point at which a person is detected by the repeater and the reception device, and
further performs movement control of the repeater such that the sensing information can be acquired from a sensor that is in a predicted movement direction of the person.

### (Supplementary Note 11)

A wireless communication method performed by a reception device that constitutes a wireless communication system, the method including the step of:

performing movement control of an own device based on a transmission timing of sensing information of a sensor, an installation position of the sensor, and a range in which reception is possible in a case where the sensing information is received from the sensor, and then receiving the sensing information of the sensor.

### (Supplementary Note 12)

The wireless communication method performed by a reception device according to supplementary note 11, wherein
the wireless communication system further includes a repeater that is capable of self-propelled movement, that receives the sensing information from the sensor, and relays the received sensing information to the reception device, and
the reception device, in a case where it is a device that is capable of transferring the received sensing information to a data processing system,
further performs movement control of the repeater based on a transmission timing of the sensing information of the sensor, the installation position of the sensor, and a range in which reception is possible in a case where the repeater receives the sensing information from the sensor, and
receives the sensing information of the sensor via the repeater.

### (Supplementary Note 13)

The wireless communication method performed by a reception device according to claim 12, wherein
movement control of the repeater is performed such that an own movement distance is minimized in a position where transmission and reception is possible with respect to the repeater, and in a case where the sensing information is received from the sensor via the repeater.

### (Supplementary Note 14)

The wireless communication method performed by a reception device according to supplementary note 12 or 13, wherein
grouping is performed in a case where there are a plurality of sensors, where the plurality of sensors are grouped in a group that causes a distance between each sensor from an installation position of each sensor to be less than or equal to a predetermined value, and
movement control of the repeater is performed such that the repeater can receive the sensing information at a predetermined time point from all of the sensors included in the group.

### (Supplementary Note 15)

The wireless communication method performed by a reception device according to supplementary note 14, wherein
for each sensor, a time point at which the sensor next transmits the sensing information is predicted based on a reception time of the last received sensing information, and
in a case where it is determined that, based on the predicted next time point at which the sensing information is transmitted, it is not possible to receive the sensing information from all of the sensors included in the group at a predetermined time point, a control is performed that causes all of the sensors included in the group to be temporarily disabled, and then enabled.

### (Supplementary Note 16)

The wireless communication method performed by a reception device according to supplementary note 14 or 15, wherein
in a case where the wireless communication system includes a plurality of repeaters,
further grouping of the group is performed based on position information of the group and the number of repeaters, and then a repeater is assigned to each group that has been further grouped, and
in a case where the sensing information is received from a sensor belonging to a predetermined group, movement control is performed of a repeater that has been assigned to a group that has been further grouped, to which the predetermined group belongs, and the sensing information of the sensor that belongs to the predetermined group is received via the repeater with respect to which movement control has been performed.

### (Supplementary Note 17)

The wireless communication method performed by a reception device according to any one of supplementary notes 14 to 16, wherein
the range in which reception is possible in a case where the repeater receives the sensing information from all of the sensors belonging to the group is adjusted based on a reception strength in a case where the repeater receives the sensing information from the sensor.

### (Supplementary Note 18)

The wireless communication method performed by a reception device according to any one of supplementary notes 12 to 17, wherein
the sensor is a human presence sensor,
and in a case where the wireless communication system is provided with a plurality of predictive detection human presence sensors that are different from the sensor, and are installed in a fixed manner in order to perform movement detection prediction of a person, and/or
the repeater and the reception device are each provided with a human presence sensor,
a movement direction of a person is predicted based on a time point at which a person is detected by the predictive detection human presence sensor, and an installation position of the predictive detection human presence sensor, and/or based on a time point at which a person is detected by the repeater and the reception device, and
movement control of the repeater is further performed such that the sensing information can be acquired from a sensor that is in a predicted movement direction of the person.

### (Supplementary Note 21)

A program for a reception device that constitutes a wireless communication system, the program causing a computer to execute the step of:
performing movement control of an own device based on a transmission timing of sensing information of a sensor, an installation position of the sensor, and a range in which reception is possible in a case where the sensing information is received from the sensor, and then receiving the sensing information of the sensor.

### (Supplementary Note 22)

The program for a reception device according to supplementary note 21, wherein
the wireless communication system further includes a repeater that is capable of self-propelled movement, that receives the sensing information from the sensor, and relays the received sensing information to the reception device, and
the reception device, in a case where it is a device that is capable of transferring the received sensing information to a data processing system,
further performs movement control of the repeater based on a transmission timing of the sensing information of the sensor, the installation position of the sensor, and a range in which reception is possible in a case where the repeater receives the sensing information from the sensor, and
receives the sensing information of the sensor via the repeater.

### (Supplementary Note 23)

The program for a reception device according to supplementary note 22, wherein
movement control of the repeater is performed such that an own movement distance is minimized in a position where transmission and reception is possible with respect to the repeater, and in a case where the sensing information is received from the sensor via the repeater.
   (Supplementary note 24)

The program for a reception device according to supplementary note 22 or 23, wherein
grouping is performed in a case where there are a plurality of sensors, where the plurality of sensors are grouped in a group that causes a distance between each sensor from an installation position of each sensor to be less than or equal to a predetermined value, and
movement control of the repeater is performed such that the repeater can receive the sensing information at a predetermined time point from all of the sensors included in the group.
   (Supplementary note 25)

The program for a reception device according to supplementary note 24, wherein
for each sensor, a time point at which the sensor next transmits the sensing information is predicted based on a reception time of the last received sensing information, and
in a case where it is determined that, based on the predicted next time point at which the sensing information is transmitted, it is not possible to receive the sensing information from all of the sensors included in the group at a predetermined time point, a control is performed that causes all of the sensors included in the group to be temporarily disabled, and then enabled.

### (Supplementary Note 26)

The program for a reception device according to supplementary note 24 or 25, wherein
in a case where the wireless communication system includes a plurality of repeaters,
further grouping of the group is performed based on position information of the group and the number of repeaters, and then a repeater is assigned to each group that has been further grouped, and
in a case where the sensing information is received from a sensor belonging to a predetermined group, movement control is performed of a repeater that has been assigned to a group that has been further grouped, to which the predetermined group belongs, and the sensing information of the sensor that belongs to the predetermined group is received via the repeater with respect to which movement control has been performed.

### (Supplementary Note 27)

The program for a reception device according to any one of supplementary notes 24 to 26, wherein
the range in which reception is possible in a case where the repeater receives the sensing information from all of the sensors belonging to the group is adjusted based on a reception strength in a case where the repeater receives the sensing information from the sensor.

### (Supplementary Note 28)

The program for a reception device according to any one of supplementary notes 22 to 27, wherein
the sensor is a human presence sensor,
and in a case where the wireless communication system is provided with a plurality of predictive detection human presence sensors that are different from the sensor, and are installed in a fixed manner in order to perform movement detection prediction of a person, and/or
the repeater and the reception device are each provided with a human presence sensor,
a movement direction of a person is predicted based on a time point at which a person is detected by the predictive detection human presence sensor, and an installation position of the predictive detection human presence sensor, and/or based on a time point at which a person is detected by the repeater and the reception device, and
movement control of the repeater is further performed such that the sensing information can be acquired from a sensor that is in a predicted movement direction of the person.

What is claimed is:

1. A wireless communication system comprising:
a receiver configured to be capable of self-propelled movement, and including at least one first memory configured to store first instructions and at least one first processor configured to execute the first instructions to:
perform movement control of the receiver based on a transmission timing of sensing information of a sensor, an installation position of the sensor, and a range in which reception is possible in a case where the sensing information is received from the sensor; and
receive the sensing information of the sensor.

2. The wireless communication system according to claim 1 further comprising a repeater configured to be capable of self-propelled movement, and including at least one second memory configured to store second instructions and at least one second processor configured to execute the second instructions to:
receive the sensing information from the sensor; and
relay the received sensing information to the receiver,
wherein the receiver is capable of transferring the received sensing information to a data processing system, and wherein the at least one first processor is configured to execute the first instructions to:
perform movement control of the repeater based on a transmission timing of the sensing information of the sensor, the installation position of the sensor, and a range in which reception is possible in a case where the repeater receives the sensing information from the sensor; and
receive the sensing information of the sensor via the repeater.

3. The wireless communication system according to claim 2, wherein the at least one first processor is configured to execute the first instructions to perform movement control of the repeater such that an own movement distance is minimized in a position where transmission and reception is possible with respect to the repeater, and in a case where the sensing information is received from the sensor via the repeater.

4. The wireless communication system according to claim 2, wherein the at least one first processor is configured to execute the first instructions to:
perform grouping in a case where there are a plurality of sensors, where the plurality of sensors are grouped in a group that causes a distance between each sensor from an installation position of each sensor to be less than or equal to a predetermined value; and
perform movement control of the repeater such that the repeater can receive the sensing information at a predetermined time point from all of the sensors included in the group.

5. The wireless communication system according to claim 4, wherein the at least one first processor is configured to execute the first instructions to:
predict, for each sensor, a time point at which the sensor next transmits the sensing information based on a reception time of the last received sensing information, and
in a case where it is determined that, based on the predicted next time point at which the sensing information is transmitted, it is not possible to receive the sensing information from all of the sensors included in the group at a predetermined time point, perform a control that causes all of the sensors included in the group to be temporarily disabled, and then enabled.

6. The wireless communication system according to claim 4, wherein the repeater includes a plurality of repeaters, and the at least one first processor is configured to execute the first instructions to:
perform further grouping of the group based on position information of the group and the number of repeaters, and then assigns a repeater to each group that has been further grouped, and
in a case where the sensing information is received from a sensor belonging to a predetermined group, perform movement control of a repeater that has been assigned to a group that has been further grouped, to which the predetermined group belongs, and receive the sensing information of the sensor that belongs to the predetermined group via the repeater with respect to which movement control has been performed.

7. The wireless communication system according to claim 4, wherein the at least one first processor is configured to execute the first instructions to adjust the range in which reception is possible in a case where the repeater receives the sensing information from all of the sensors belonging to the group based on a reception strength in a case where the repeater receives the sensing information from the sensor.

8. The wireless communication system according to claim 2, wherein
the sensor is a human presence sensor,
the wireless communication system includes a plurality of predictive detection human presence sensors that are different from the sensor, and are installed in a fixed manner in order to perform movement detection prediction of a person, and/or
the repeater and the receiver each include a human presence sensor, and
wherein the at least one first processor is configured to execute the first instructions to:
predict a movement direction of a person based on a time point at which a person is detected by the predictive detection human presence sensor, and an installation position of the predictive detection human presence sensor, and/or based on a time point at which a person is detected by the repeater and the reception device, and
perform movement control of the repeater such that the sensing information can be acquired from a sensor that is in a predicted movement direction of the person.

9. A wireless communication method performed by a receiver included in a wireless communication system, the method comprising:
performing, by the receiver, movement control of the receiver based on a transmission timing of sensing information of a sensor, an installation position of the sensor, and a range in which reception is possible in a case where the sensing information is received from the sensor; and
receiving, by the receiver, the sensing information of the sensor.

10. The wireless communication method according to claim 9, wherein the wireless communication system further includes a repeater configured to be capable of self-propelled movement, and wherein the method further comprises:
receiving, by the repeater, the sensing information from the sensor; and
relaying, by the repeater, the received sensing information to the receiver,
wherein the receiver is capable of transferring the received sensing information to a data processing system, and wherein the method further comprises:
performing, by the receiver, movement control of the repeater based on a transmission timing of the sensing information of the sensor, the installation position of the sensor, and a range in which reception is possible in a case where the repeater receives the sensing information from the sensor; and
receiving, by the receiver, the sensing information of the sensor via the repeater.

11. The wireless communication method according to claim 10 further comprising performing, by the receiver, movement control of the repeater such that an own movement distance is minimized in a position where transmission and reception is possible with respect to the repeater, and in a case where the sensing information is received from the sensor via the repeater.

12. The wireless communication method according to claim 10 further comprising:
performing, by the receiver, grouping in a case where there are a plurality of sensors, where the plurality of sensors are grouped in a group that causes a distance between each sensor from an installation position of each sensor to be less than or equal to a predetermined value; and
performing, by the receiver, movement control of the repeater such that the repeater can receive the sensing information at a predetermined time point from all of the sensors included in the group.

13. The wireless communication method according to claim 12 further comprising:
predicting, by the receiver, for each sensor, a time point at which the sensor next transmits the sensing information based on a reception time of the last received sensing information, and
in a case where it is determined that, based on the predicted next time point at which the sensing information is transmitted, it is not possible to receive the sensing information from all of the sensors included in the group at a predetermined time point, performing, by the receiver, a control that causes all of the sensors included in the group to be temporarily disabled, and then enabled.

14. The wireless communication method according to claim 12, wherein the receiver includes a plurality of repeaters, and wherein the method further comprises:
performing, by the receiver, further grouping of the group based on position information of the group and the number of repeaters, and then assigns a repeater to each group that has been further grouped, and
in a case where the sensing information is received from a sensor belonging to a predetermined group, performing, by the receiver, movement control of a repeater that has been assigned to a group that has been further grouped, to which the predetermined group belongs, and receiving the sensing information of the sensor that belongs to the predetermined group via the repeater with respect to which movement control has been performed.

15. The wireless communication method according to claim 12 further comprising adjusting, by the receiver, the range in which reception is possible in a case where the repeater receives the sensing information from all of the sensors belonging to the group based on a reception strength in a case where the repeater receives the sensing information from the sensor.

16. The wireless communication method according to claim 10, wherein
the sensor is a human presence sensor,
the wireless communication system includes a plurality of predictive detection human presence sensors that are different from the sensor, and are installed in a fixed manner in order to perform movement detection prediction of a person, and/or
the repeater and the receiver each include a human presence sensor, and
wherein the method further comprises:
predicting, by the receiver, a movement direction of a person based on a time point at which a person is detected by the predictive detection human presence sensor, and an installation position of the predictive detection human presence sensor, and/or based on a time point at which a person is detected by the repeater and the reception device, and
performing, by the receiver, movement control of the repeater such that the sensing information can be acquired from a sensor that is in a predicted movement direction of the person.

17. A non-transitory storage medium storing a program for a receiver included in a wireless communication system, the program causing a computer to execute:
performing movement control of the receiver based on a transmission timing of sensing information of a sensor, an installation position of the sensor, and a range in which reception is possible in a case where the sensing information is received from the sensor; and
receiving the sensing information of the sensor.
